(19) United States
(12) Patent Application Publication
(10) Pub. No.: US 2021/0289912 A1
(43) Pub. Date: Sep. 23, 2021

(54) WIRELESSLY CONNECTED MANICURE MACHINE AND WIRELESS CONNECTION SYSTEM OF MANICURE MACHINE

(71) Applicant: COSMEX CO., LTD., New Taipei City (TW)

(72) Inventors: WAN-CHIEH HSIEH, New Taipei City (TW); HAO-HONG CIOU, New Taipei City (TW); LIN-YU SIA, New Taipei City (TW); CHUN-CHING LIU, New Taipei City (TW)

(21) Appl. No.: 17/200,016

(22) Filed: Mar. 12, 2021

(30) Foreign Application Priority Data
Mar. 23, 2020 (TW) 109203303

(51) Int. Cl. A45D 29/00; G08C 17/02; A45D 44/00

(52) U.S. Cl. CPC A45D 29/00; A45D 2200/205; A45D 44/005; G08C 17/02

(57) ABSTRACT

The present invention provides a wirelessly connected manicure machine, which includes a housing, a control module, an input interface and a wireless communication module. The housing has an internal cavity, an opening corresponding to one side of the internal cavity, and one or more ultraviolet light emitting diode (UV LED) modules provided in the internal cavity. The input interface is connected to the control module to input a corresponding trigger instruction to the control module. The control module is connected to the UV LED module. The control module is also connected to the wireless communication module to send and receive signals through the wireless communication module.

### BACKGROUND OF THE INVENTION

### 1. Technical Field

The present invention relates to a manicure machine, in particular to a wirelessly connected manicure machine and a wireless connection system of the manicure machine.

### 2. Description of Related Art

Phototherapy manicure (or gel manicure) is mainly to coat a layer of non-toxic pure natural resin material on the surface of the nail, and then to use ultraviolet light to solidify the resin material, thereby forming a protective layer on the surface of the nail, which can increase the toughness and elasticity of the nail and prevent the nail from breaking. Resin materials can also be used to correct the shape of nails, and the resin materials have different colors and transmittances, which can add luster to the nails.

A general light curing device is mainly composed of a housing, a light curing chamber in the housing, and an operation panel provided on the housing. It solidifies and hardens the resin material by ultraviolet light. It has the advantages of fast response, short curing time, high energy efficiency, and can be operated at room temperature; in addition, the resin material does not contain organic solvents. Therefore, it allows users to beautify and maintain their nails under a comfortable state without harming the human body. The user can input instructions on the operation panel to make the light curing device perform corresponding operations, and can confirm the current working state of the light curing device from the information displayed on the operation panel, such as the brightness and time of ultraviolet light irradiation, and the current working mode.

The manicure machine has been subjected to basic initial settings at the factory, but each user has their own unique usage habits or operating preferences. The initial setting mode cannot meet the needs of different users, and it is prone to unsatisfactory operation or wrong operation, and the functions of the manicure machine cannot be used efficiently. In the conventional technology, there are still many problems to be improved in the way of actually operating the manicure machine. In view of this, the inventor believes that it is necessary to conceive a manicure machine or manicure machine system that can be provided for the users with intelligent services, and allow the users to make various personalized settings according to their own needs to meet the user's preferences and requirements, and enhance the flexibility and variability of the manicure machine in actual use.

### BRIEF SUMMARY OF THE INVENTION

The primary objective of the present invention is to provide a manicure device or its system capable of wireless connection.

In order to achieve the above objective, the present invention provides a wirelessly connected manicure machine, which includes a housing, a control module, an input interface and a wireless communication module. The housing has an internal cavity, an opening corresponding to one side of the internal cavity, and one or more ultraviolet light emitting diode (UV LED) modules provided in the internal cavity. The input interface is connected to the control module to input a corresponding trigger instruction to the control module. The control module is connected to the UV LED module. The control module is also connected to the wireless communication module to send and receive signals through the wireless communication module.

Another objective of the present invention is to provide a wireless connection system of manicure machine, including the abovementioned manicure machine and a mobile device. The mobile device includes a wireless transceiver module and a processor. The mobile device is connected to the wireless communication module of the manicure machine through the wireless transceiver module to access the data of the control module.

The manicure machine of the present invention is wirelessly connected with the wireless transceiver module of the mobile device through the wireless communication module so that the user can operate, confirm or adjust the current working state of the manicure machine through the mobile device, and can also obtain the past usage history of the manicure machine. This is different from the previous use mode that can only be operated through the manicure machine, and adds more mobility, convenience and safety to actual use.

### BRIEF DESCRIPTION OF THE SEVERAL VIEWS OF THE DRAWINGS

FIG. 1 is a block diagram of the wireless connection system of the present invention.

FIG. 2 is an outer appearance perspective view of the manicure machine of the present invention.

FIG. 3 is a comparison diagram of the look-up table of the present invention.

FIG. 4 is an outer appearance perspective view of the mobile device of the present invention.

FIG. 5 is a schematic diagram of the manicure editing interface of the present invention.

FIG. 6 is a schematic diagram of the manicure information interface of the present invention.

FIG. 7 is a schematic diagram of the connection of the manicure machine, the mobile device, and the data control center of the present invention.

### DETAILED DESCRIPTION OF THE INVENTION

The details and technical solution of the present invention are hereunder described with reference to accompanying drawings. For illustrative sake, the accompanying drawings are not drawn to scale. The accompanying drawings and the scale thereof are not restrictive of the present invention.

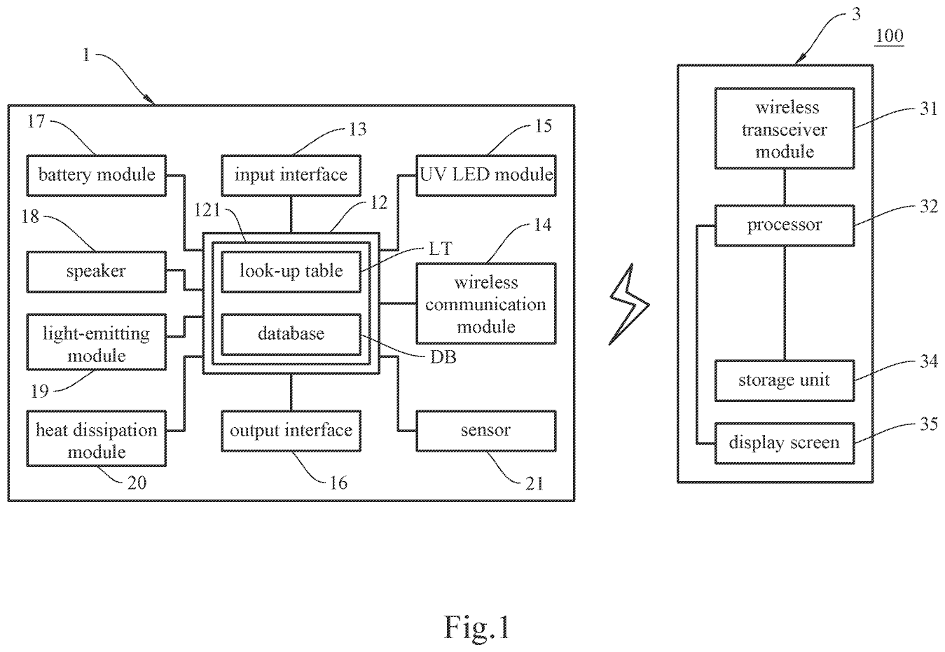

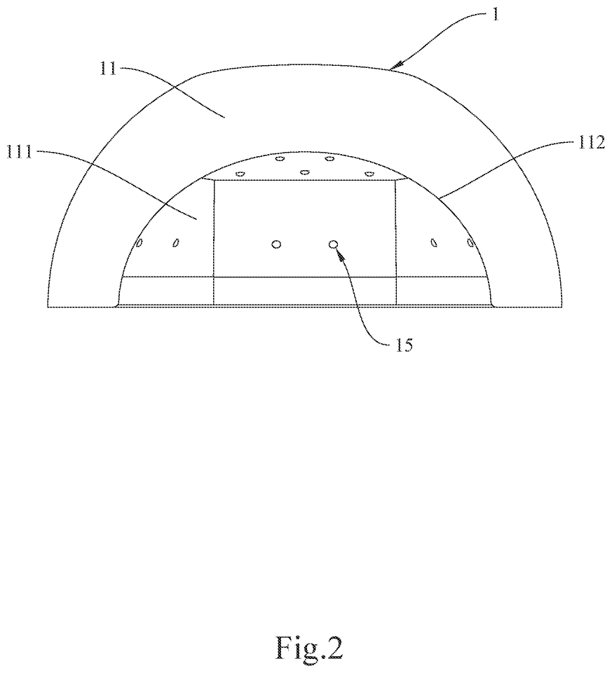

Please refer to FIG. 1 to FIG. 3, showing a block diagram of the wireless connection system, an outer appearance perspective view of the manicure machine, and a comparison diagram of the look-up table of the present invention respectively. As shown in the drawings:

The present invention discloses a wireless connection system 100, including a manicure machine 1 and a mobile device 3. The manicure machine 1 and the mobile device 3 can be wirelessly connected for information transmission, and the mobile device 3 can be used to control the working state of the manicure machine 1. The user can control the manicure machine 1 through various mobile applications (APP) of the mobile device 3. In a preferred embodiment, in addition to transmitting information via a wireless connection with the mobile device 3, the manicure machine 1 can also be wirelessly connected to various hardware devices, such as nail polishers, sterilizers, dust collectors, or charging devices; the present invention has no limitation in this regard. In another preferred embodiment, the manicure machine 1 can be connected to a hardware device through a physical circuit or structure; for example, the manicure machine 1 and the hardware device respectively have connectable plugs and sockets to allow the manicure machine 1 to supply power to the hardware device, or the manicure machine 1 and the hardware device can be connected or combined through a magnetic structure, a buckle structure, a lock screw structure, or an insertion structure so that the manicure machine 1 and the hardware device can be co-constructed or integrated; the present invention has no limitation in this regard.

The wireless connection in the present invention can be any methods that allow the manicure machine 1 to be wirelessly connected with other electronic devices, such as Wi-Fi Direct, Bluetooth, Wi-Fi Soft-AP, or infrared Radiation transmission; the invention has no limitation in this regard.

The manicure machine 1 in the present invention is a light curing device, which is used to irradiate the user's fingernails and/or toenails with UV light to cure the gel coated on the surface of the fingernails and/or toenails. The manicure machine 1 may include a housing 11, a control module 12, an input interface 13, a wireless communication module 14, a UV LED module 15, an output interface 16, a battery module 17, a speaker 18, a light-emitting module 19, a heat dissipation module 20, and at least one sensor 21.

The housing 11 has an internal cavity 111, an opening 112 corresponding to one side of the internal cavity 111, and one or more UV LED modules 15 provided in the internal cavity 111. The user can put the hands and/or feet to be photocured into the internal cavity 111 through the opening 112 so that the fingernails and/or toenails are irradiated by the UV light generated by the UV LED module 15.

Specifically, the UV LED module 15 may include a substrate and a plurality of UV LEDs provided on the substrate. When the UV LED module 15 emits the light, the UV LED irradiates UV light toward the bottom side of the internal cavity 111. In order to improve the photocuring efficiency of the UV LED module 15, the UV LED module 15 may further include a plurality of reflective cups surrounding the UV LED. The reflective cup has light reflection characteristics, which not only allow the UV light generated by the UV LED to irradiate toward the bottom side of the internal cavity 111, but also the UV light to irradiate toward various positions of the fingernails and/or toenails more easily. In order to improve the use efficiency of the UV light generated by the UV LED module 15, the direction and angle of the inner peripheral wall surface of the internal cavity 111 are set in accordance with the position of the fingernails and/or toenails, and the inner peripheral wall surface has light reflection characteristics, which allow the UV light to be fully utilized.

The input interface 13 is connected to the control module 12 to input a corresponding trigger instruction to the control module 12. The control module 12 is connected to the UV LED module 15. The control module 12 is also connected to the wireless communication module 14 to send and receive signals through the wireless communication module 14. The wireless communication module 14 can be a Bluetooth module, a Wi-Fi transmission module, a radio frequency identification (RFID) module, an infrared transmission module, etc.; the present invention has no limitation in this regard. On the other hand, the control module 12 can execute the corresponding trigger instruction according to the preset instruction or condition of the software program of the manicure machine 100. For example, when the manicure machine 100 is turned on, the current information of the manicure machine 100 is automatically stored after a preset time. The invention has no limitation in the preset instruction or condition of the manicure machine 100 and the corresponding trigger instruction.

Specifically, the input interface 13 may be a physical or virtual button, a touch screen, a light sensor, or any other man-machine interface or sensing device that can be used by the user to control the manicure machine 1 provided in the housing 11. In a preferred embodiment, the input interface 13 can be a capacitive touch button. When the users hand approaches or touches the button, the sensing capacitance value of the button changes, and the corresponding trigger instruction can be input to the control module 12. In another preferred embodiment, the input interface 13 can be a light blocking sensor provided in the internal cavity 111. When the users hands and/or feet are put into the internal cavity 111, the light will be blocked, so the light blocking sensor detects the change of the light, and then inputs the corresponding trigger instruction to the control module 12.

Specifically, the control module 12 can be executed cooperatively by a single chip or a combination of a plurality of chips, and the number of such chips is not within the scope of the present invention. The chip may be, but is not limited to, a processor, a central processing unit (CPU), a microprocessor, a digital signal processor (DSP), an application specific integrated circuit (ASIC), a programmable logic device (PLD), or other similar devices that can convert information or signals for processing and conversion purposes or for special purposes, or combinations of these devices; the present invention has no limitation in this regard.

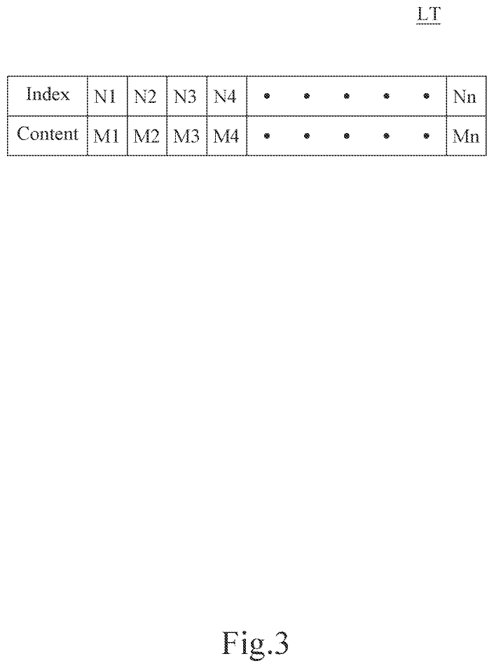

The control module 12 may include a storage unit 121. The storage unit 121 includes a look-up table LT. As shown in FIG. 3, the look-up table LT may include a plurality of nail polish information N1-Nn as indexes and a plurality of light-emitting mode information M1-Mn corresponding to the nail polish information N1-Nn, respectively. Specifically, the nail polish information N1-Nn may be information such as the number or code of the nail polish, and the light-emitting mode information M1-Mn may be light curing conditions corresponding to the nail polish information N1-Nn, such as the output power, lighting time, and working mode of the UV LED module 15. In actual use, when the user inputs the nail polish information N1, the corresponding trigger instruction is input to the control module 12, and the corresponding light-emitting mode information M1 is found in the look-up table LT so that the UV LED module 15 executes the light-emitting mode information M1, that is, the UV light generated by the UV LED module 15 meets the conditions for the nail polish information N1 to complete the light curing.

The storage unit 121 further includes a database DB. The database DB stores the operation records, environmental information, manufacturing information and other information of the manicure machine 1 so that the user can confirm and adjust the current working state of the manicure machine 1 through the manicure machine 1 or the mobile device 3, and can also obtain the past usage history of the manicure machine 1. Specifically, the operation record may be the previous working mode, common working mode, user personal data, etc. of the manicure machine 1 so that the user can confirm the previously used mode and data. The above-mentioned working mode may be, for example, but not limited to, the operation mode of various modules and/or various sensors 21 of the manicure machine 1, which will be described in detail in the following paragraphs of the present invention. The environmental information may be the working state of any or all components of the manicure machine 1, such as the output power and/or lighting time of the UV LED module 15 and the power status of the battery module 17. The environmental information can not only display and provide the user to grasp the working state of the manicure machine 1 in real time, but also integrate and analyze the usage history of the manicure machine 1 by storing the working state (e.g., the number of times and/or the length of time of using the UV LED module 15 in a predetermined period) of the manicure machine 1 regularly or at any time, which helps to obtain the user's use frequency or habits. The manufacturing information may be the model, manufacturing date, manufacturer, etc. of the manicure machine 10 so that the user can further obtain equipment or devices suitable for the manicure machine. The information stored in the database DB in the present invention is not limited to the above specific implementation. When the user controls the manicure machine 1, any software and hardware related information can be stored in the database DB. In order to facilitate the creation of files in the database DB, the nail polish information N1-Nn in the present invention can be used as an index to further store the characteristics, usage, and precautions of the nail polish corresponding to the nail polish in the database DB; the invention has no limitation in this regard.

The output interface 16 is connected to the control module 12 to output corresponding man-machine signals according to the control instruction of the control module 12 so that the user can confirm the current working state of the manicure machine 1 through the output interface 16. Specifically, the output interface 16 may be a display, a sound device, a light source device, or any other man-machine interface or acousto-optic device provided in the housing 11 that can be used to confirm the current working state of the manicure machine 1. The display can be, but is not limited to, a digital display, a liquid crystal display, or an organic light emitting diode (OLED) display. In a preferred embodiment, the display can be a touch screen, a display screen, a digital screen, etc., for the user to confirm the current working state of the manicure machine 1. In another preferred embodiment, the display, the sound device (such as the speaker 18), and the light source device (such as the light-emitting module 19) can be independent or co-constructed as an output interface 16, and the user can confirm the current state of the manicure machine 1 visually and/or acoustically.

The control module 12 is connected to a battery module 17 that provides operating power to the UV LED module 15. In a preferred embodiment, the battery module 17 may be a power supply fixedly provided in the housing 11 to provide a power source for the operation of the manicure machine 1. In another preferred embodiment, the battery module 17 can be a rechargeable battery device. When the power of the rechargeable battery device is insufficient or exhausted, the rechargeable battery device can be charged in a wired or wireless manner to restore its power. On the other hand, the rechargeable battery device may include a detachable housing, a control unit, and a replaceable battery unit. The replaceable battery unit is provided by the detachable housing and is electrically connected to the control unit. When the power of the replaceable battery unit is insufficient or exhausted, the user can take apart the detachable housing and replace another replaceable battery unit with power. Or the rechargeable battery device is electrically connected to an external power supply device via a power supply line, and the control unit controls the replaceable battery unit to receive and store the power transmitted from the external power supply device to charge the replaceable battery unit to restore its power. Alternatively, the rechargeable battery device may include a housing, a control unit, and a rechargeable battery unit electrically connected to the control unit and provided in the housing. When the power of the rechargeable battery device is insufficient or exhausted, the user can replace the rechargeable battery device with another rechargeable battery device with power or electrically connect the rechargeable battery device to an external power supply device through a power supply line, and the control unit controls the rechargeable battery unit to receive and store the power transmitted from the external power supply device to charge it. The present invention can improve the practicability and convenience of the manicure machine 1 by charging or replacing the rechargeable battery device, and has no limitation on the specific implementation of the rechargeable battery device.

The control module 12 outputs the power information of the battery module 17 to the output interface 16 according to the trigger instruction and the output interface 16 displays the power information for the user to confirm the remaining power of the battery module 17. In a preferred embodiment, the control module 12 can calculate the power information according to the voltage value of the battery module 17. Specifically, when the battery module 17 is discharged, the voltage of the battery module 17 will gradually drop as the power is lost, and the control module 12 calculates the corresponding remaining power through the corresponding relationship between the voltage and the power. In another preferred embodiment, the control module 12 can calculate the power information according to the stage of charge of the battery module 17. Specifically, the stage of charge can be defined as the state of available electrical energy in the battery module 17, and the control module 12 mainly estimates the power information through parameters such as battery voltage, charge and discharge current, and internal resistance. The present invention has no limitation on the method of calculating the power information of the battery module 17, and is not limited to the abovementioned specific embodiments.

The control module 12 outputs the battery life information of the battery module 17 to the output interface 16 according to the trigger instruction so that the output interface 16 displays the battery life information, or the control module 12 stores the battery life information in the storage unit 121. The battery life information can be stored in the database DB of the storage unit 121. In a preferred embodiment, the control module 12 can calculate the battery life information according to the charging and discharging time of the battery module 17. Specifically, the number of times the battery module 17 can be recharged multiplied by the depth of discharge (the percentage of battery discharge capacity to battery rated capacity) is equal to the actual battery life of the battery module 17. In another preferred embodiment, the control module 12 can further calculate the battery life information according to parameters such as the charging and discharging time of the battery module 17 and the environmental temperature to improve the accuracy of the calculation result. The present invention has no limitation on the method of calculating the battery life information of the battery module 17, and is not limited to the abovementioned specific implementation.

The housing 11 may be provided with a speaker 18 connected to the control module 12. The control module 12 executes the corresponding sound information according to the trigger instruction and the speaker 18 outputs the sound information, which can provide different sound changes and/or function instructions according to the working state of the manicure machine 1, so that the user can confirm the current working state of the manicure machine 1, and the sound information can also increase the auditory effect and create an atmosphere of use. Specifically, in the present invention, the output power, lighting time, working mode, etc. of the UV LED module 15 can be confirmed through the sound change of the speaker 18, so the user does not need to look at the output interface 16 to confirm the current working state of the manicure machine 1. On the other hand, the user can adjust the speaker 18 through the input interface 13 or the mobile device 3, and the control module 12 executes corresponding sound information according to the trigger instruction, such as adjusting the volume, loading and/or selecting music to play, or executes various situational music modes, so as to change the state of the speaker 18.

The housing 11 may be provided with a light-emitting module 19 connected to the control module 12. The control module 12 adjusts the light-emitting color, light-emitting brightness and/or light-emitting position of the light-emitting module 19 according to the trigger instruction. The light-emitting module 19 can provide different light changes and/or function indications according to the working state of the manicure machine 1 so that the user can confirm the current working state of the manicure machine 1, and can also increase visual effects and create a use situation. Specifically, in the present invention, the output power, lighting time, working mode, etc. of the UV LED module 15 can be confirmed through the color change of the light-emitting module 19, so the user does not need to look at the output interface 16 to confirm the current working state of the manicure machine 1. On the other hand, the user can adjust the light-emitting module 19 through the input interface 13 or the mobile device 3, and the control module 12 executes corresponding light-emitting information such as adjusting light brightness or color temperature or executes various situational light modes according to the trigger instruction, so as to change the state of the light-emitting module 19.

The light-emitting module 19 may be composed of a plurality of RGB three-color light emitting diodes (LEDs), each of which has a red LED, a green LED, and a blue LED, representing three different basic colors. The control module 12 adjusts the output power of the RGB three-color LEDs to different values according to the trigger instruction to generate different colors so that the light-emitting color, light-emitting brightness and/or light-emitting position of the light-emitting module 19 are changed.

The light-emitting module 19 can be provided at any position of the housing 11 to produce different light effects. In a preferred embodiment, the light-emitting module 19 can be provided inside the housing 11 and covered by the housing 11, wherein the position of the housing 11 corresponding to the light-emitting module 19 can be made of transparent or semi-transmissive material to produce a slightly transparent light effect. In another preferred embodiment, the light-emitting module 19 can be provided on the outside of the housing 11, and the housing 11 is provided with a hole at a position corresponding to the light-emitting module 19, so that the light generated by the light-emitting module 19 is directly exposed.

In order to prevent the heat source generated by the UV LED module 15 during operation from being concentrated and not easily dissipated, which may shorten the life of the electronic components of the manicure machine 1 or cause other safety concerns, the manicure machine 1 is further provided with a heat dissipation module 20 connected to the control unit 12, and the heat dissipation module 20 can be provided between the housing 11 and the UV LED module 15. In a preferred embodiment, the heat dissipation module 20 can be a heat dissipation fins, a fan, a metal substrate (which can be made of metal materials with high conductivity, such as aluminum, copper, aluminum alloy, copper alloy, etc.) or a combination of the foregoing components provided on the UV LED module 15, and absorbs and dissipates the heat generated by the operation of the UV LED module 15 through the heat dissipation fins, the fan and/or the metal substrate. In another preferred embodiment, the housing 11 may be provided with a plurality of heat dissipation holes (not shown) corresponding to the position of the heat dissipation module 20 to facilitate the dissipation of heat sources in the housing 11.

The sensor 21 can be provided on the housing 11 to receive and trigger a sensing signal, and the control module 12 is connected to the sensor 21 to receive the sensing signal of the sensor 21. The working state of the sensor 21 can be stored in the database DB, and the user can obtain the current working state and past usage history of the sensor 21 through the output interface 16 or the mobile device 3. Specifically, the user can install the sensor 21 inside or outside the housing 11 according to the actual application requirements of the sensor 21. The sensor 21 in the present invention can be a hand gesture signal sensor, a photosensor, a distance sensor, an acceleration sensor, a magnetic field sensor, a gyroscope, a GPS (Global Positioning System) device, a heart rate sensor, a UV light sensor, a temperature sensor, a gas sensor, a radio frequency identification (RFID) device, a dust sensor, a position detector and/or a virtual image key sensor. People in the industry can set up a sensor capable of detecting specific sensing signals in the manicure machine 1 according to actual needs so that users can obtain multiple information. The invention has no limitation on the application type and the number of installations of the sensor 21. In one embodiment, an electronic tag may be provided on the product package of the nail polish, a nail polish information of the nail polish recorded in the electronic tag, and the user can read the electronic tag by the radio frequency identification (RFID) device to obtain and input the nail polish information.

For example, the sensor 21 may be a temperature sensor for sensing temperature (such as the environmental temperature or the temperature of the manicure machine 1) to obtain temperature parameters and feedback to the control module 12 to input corresponding trigger instruction, and the control module 12 can output a corresponding control instruction according to the trigger instruction. In a preferred embodiment, when the temperature sensor detects that the temperature parameter of the internal cavity 111 shows abnormal conditions such as excessively high temperature or unstable temperature, the temperature sensor inputs an alarm trigger instruction to the control module 12, and the control module 12 outputs a corresponding control instruction to the output interface 16 (such as a display, the speaker 18 or the light-emitting module 19) to warn the user. In another preferred embodiment, when the temperature sensor detects that the temperature parameter of the internal cavity 111 shows that the temperature is too high or the temperature is unstable, the temperature sensor inputs a control instruction for automatically adjusting the temperature to the control module 12, and the control module 12 outputs a corresponding control instruction to the heat dissipation module 20, so that the temperature of the manicure machine 1 is automatically adjusted to an appropriate temperature, so as to avoid harming the human body, affecting the light curing effect or damaging the manicure machine 1. In still another preferred embodiment, when the temperature sensor senses the temperature parameter of any component of the manicure machine 1 and feeds it back to the control module 12, and when the temperature parameter shows that the temperature is too high, the temperature sensor inputs a shutdown instruction to the control module 12, and the control module 12 outputs a corresponding control instruction to stop the operation of the manicure machine 1 to prevent the components in the manicure machine 1 from being damaged due to high temperature. The temperature sensor in the present invention can be a general temperature measurement device, such as but not limited to a gas thermometer, a bimetallic strip thermometer, a hydraulic thermometer, a platinum resistance thermometer, a temperature-sensing semiconductor thermometer, a thermal resistance thermometer, a thermocouple thermometer, a transistor thermometer or an ultrasonic thermometer.

For example, the sensor 21 may be a UV detector, which is used to sense the UV light in the environment to obtain UV light parameters and feedback to the control module 12 to input corresponding trigger instruction, and the control module 12 can output the corresponding control instruction according to the trigger instruction. Specifically, the UV light sensor can sense the UV light parameters of the internal cavity 111 or the UV light parameters of all or part of the UV LED module 15. In a preferred embodiment, when the UV detector detects that the UV light parameters generated by the UV LED module 15 shows that the UV light intensity is insufficient or too strong, the UV detector inputs an alarm trigger instruction to the control module 12, and the control module 12 outputs corresponding control instruction to the output interface 16 (such as a display, a speaker 18 or a light-emitting module 19) to warn that the user needs to adjust the UV light intensity or stop using the manicure machine 1 to avoid insufficient UV light that can cause nail polish to fail to cure, excessive UV light that exceeds the wavelength range required for nail polish, or excessive UV light that may harm the human body. In another preferred embodiment, when the UV detector detects that the UV light parameters generated by the UV LED module 15 indicate that the UV light intensity is insufficient or too strong, the UV detector inputs a trigger instruction for adjusting the UV light to the control module 12, and the control module 12 outputs a corresponding control instruction to the UV LED module 15 to adjust its output power, i.e., automatically adjust the UV light intensity of the UV LED module 15 to an appropriate level, so as to avoid insufficient UV light intensity to affect the curing effect or excessive UV light intensity to harm the human body. When it still shows that the intensity of the UV light generated by the UV LED module 15 is insufficient after adjustment, the control module 12 outputs a corresponding control instruction to the output interface 16 or the mobile device 3 to prompt the user to replace the UV LED of the UV LED module 15 so that the UV LED module 15 can resume normal operation. The UV light sensor in the present invention may include general devices that can be used to measure the UV light parameters, such as an aluminum gallium nitride UV detector (AlGaN UV detector), a photomultiplier tube, a silicon UV detector, a zinc oxide (ZnO) UV detector, a gallium nitride (GaN) UV detector, or an optical fiber UV detector; the invention has no limitation in this regard.

The mobile device 3 in the present invention can be a remote control, a smart mobile device, a smart wearable device, a desktop computer, a notebook computer, a tablet computer, a smart watch, or any other smart electronic devices that allow the user to control the manicure machine 1 remotely; the invention has no limitation in this regard. As shown in FIG. 1, the mobile device 3 may include a wireless transceiver module 31, a processor 32, a storage unit 34, and a display screen 35.

The mobile device 3 is connected to the wireless communication module 14 of the manicure machine 1 via the wireless transceiver module 31, so that the mobile device 3 can access the data of the control module 12 of the manicure machine 1, such as but not limited to the mobile device 3 accessing the data of the storage unit 121. Specifically, the user can obtain the operation records, environmental information, manufacturing information and other information stored in the database DB of the control module 12 through the mobile device 3 to facilitate remote confirmation of the current working state of the manicure machine 1 and obtain the past usage history of the manicure machine 1; on the other hand, the user can also control the manicure machine 1 through the mobile device 3 for such as machine opening and closing, working mode, system update, and data storage, etc. to control the manicure machine 1 remotely. The wireless transceiver module 31 can be a Bluetooth module, a Wi-Fi transmission module, a radio frequency identification (RFID) module, and an infrared Radiation (IR) module, etc.; the present invention has no limitation in this regard.

The control module 12 of the manicure machine 1 can execute the corresponding control instruction according to the trigger instruction received by the mobile device 3, and the manicure machine 1 can adjust the working mode of the control module 12 of the manicure machine 1 according to the trigger instruction of the mobile device 3. In a preferred embodiment, the user can control the manicure machine 1 through the mobile device 3 within a predetermined range where the manicure machine 1 can send and receive signals, which increase mobility and convenience to the actual use of the manicure machine 1. The aforementioned predetermined range is mainly related to the coverage and signal strength of the signal transmission and reception between the wireless communication module 14 of the manicure machine 1 and the wireless transceiver module 31 of the mobile device 3, and is not limited in the present invention. In another preferred embodiment, the mobile device 3 can also be remotely connected to the manicure machine 1 via a router, a wireless router, and a mobile phone mobile communication technology standards from the Internet, which is not limited to the predetermined range mentioned above. Through the Internet connection mode, the effect of remote teaching or remote system adjustment can be realized, which is convenient for nail art teaching or system vendors to debug and maintain products.

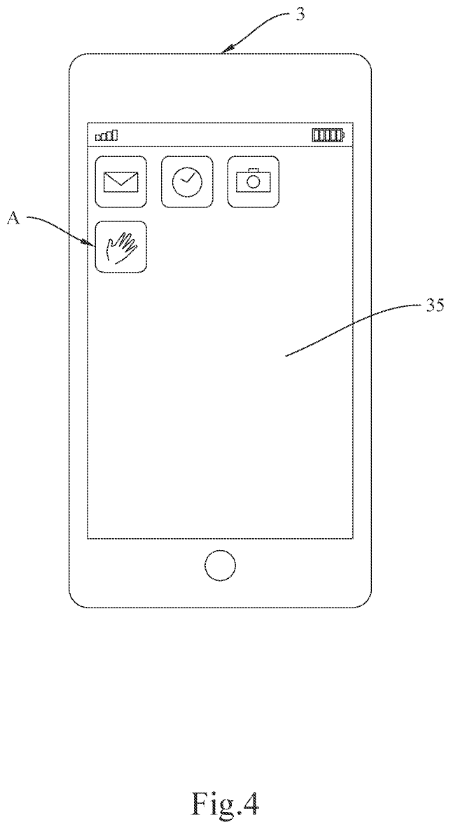

Next, please also refer to FIG. 4 showing an outer appearance perspective view of the mobile device of the present invention.

The display screen 35 of the mobile device 3 displays various icons for the user to perform different operations. The processor 32 of the mobile device 3 is connected to the storage unit 34 and executes a mobile application A by loading the storage unit 34. The user can obtain the current state of the manicure machine 1 and remotely control it through the mobile application A. Specifically, the processor 32 may be a central processing unit (CPU), a programmable general-purpose or application-specific microprocessor, a digital signal processor (DSP), a programmable controller, an application-specific integrated circuit (ASIC), a programmable logic device (PLD), other similar devices, or a combination of the above; the present invention has no limitation in this regard.

The processor 32 is connected to the display screen 35. The display screen 35 is used to display the operation records, environmental information, manufacturing information and other information of the manicure machine 1 for the user to confirm. Specifically, the display screen 35 can be an organic light emitting diode (OLED) display, a thin film transistor (TFT) display, an active matrix organic light emitting diode (AMOLED) display, etc. without limitation. In a preferred embodiment, the display screen 35 can be a touch screen with virtual buttons. In another preferred embodiment, the display screen 35 may be a display screen provided with physical buttons, or a combination type display screen controlled by virtual buttons and physical buttons respectively, so that the user can confirm the current working state of the manicure machine 1 and input a trigger instruction from the display screen 35.

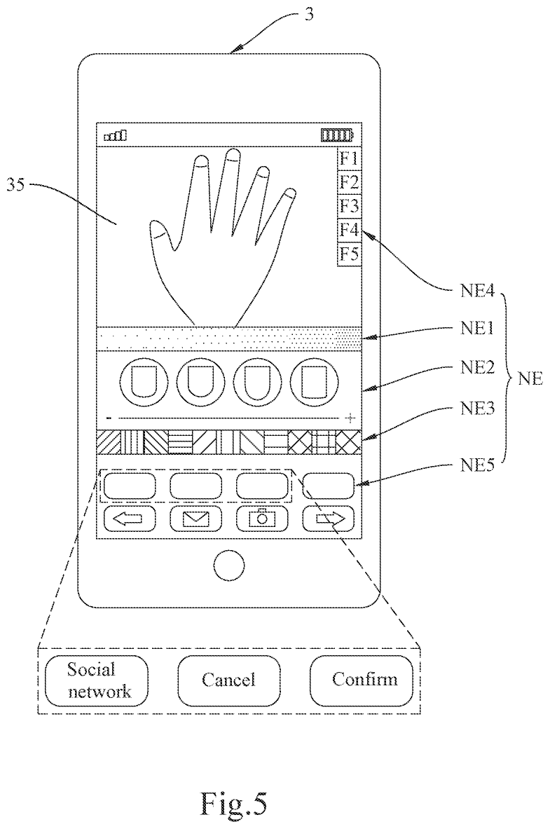

Next, please also refer to FIG. 5 showing a schematic diagram of the manicure editing interface of the present invention.

The processor 32 is connected to the storage unit 34 and executes the mobile application A by accessing the storage unit 34, thereby outputting a manicure editing interface NE on the display screen 35, and the user can perform various nail art simulations through the manicure editing interface NE. Specifically, the manicure editing interface NE is displayed on the display screen 35, wherein the manicure editing interface NE may include a plurality of menus for the user to input. The menus may include a skin color menu NE1, a nail shape menu NE2, a nail polish menu NE3, a nail position menu NE4, and/or an operation menu NE5. The user can click to enter any menu to perform a customized nail art simulation. The present invention has no limitation on the order of clicking the above menus. Specifically, the user can select the conditions to be simulated according to the state of the fingernails or toenails, for example, select the skin color from the skin color menu NE1 (the gradually dense filling lines from left to right in the figure indicate the gradation of skin color from light to dark), and select the nail shape and/or length from the nail shape menu NE2, and then select the color to be displayed from the nail polish menu NE3 (different filling lines in the figure indicate different colors such as black, red, blue, etc.), where the user can select nail positions F1 to F5 representing thumb to little finger from the nail position menu NE4, and select the nail polish to be set for different nail positions F1 to F5, for example, make the nail position F1 (i.e., thumb) show the black color of the first nail polish and make the nail positions F2 to F4 (i.e., index finger to little finger) show the red color of the second nail polish. This allows the user to simulate the effect of nail art and have time to think and confirm before actually applying the nail polish. The operation menu NE5 can display user account setting, language setting, background theme setting, software update setting, switching to a simulation screen of hand or foot, etc. The user can adjust the manicure editing interface NE to his/her habitual setting by the operation menu NE5 to avoid inconvenience or error-prone operation. The manicure editing interface NE can further display buttons with functions such as confirming operation, canceling operation, returning to the previous page, entering the next page, taking pictures, sending and receiving data, and connecting to social networking sites (as shown at the bottom of FIG. 5) for the user to perform various operations. For example, the user can capture the image of the hand/foot through the camera function of the mobile device 3, and display the image on the mobile device 3 to perform nail art simulation. The present invention does not intend to limit the functions, display positions, number, etc. of the buttons on the manicure editing interface NE.

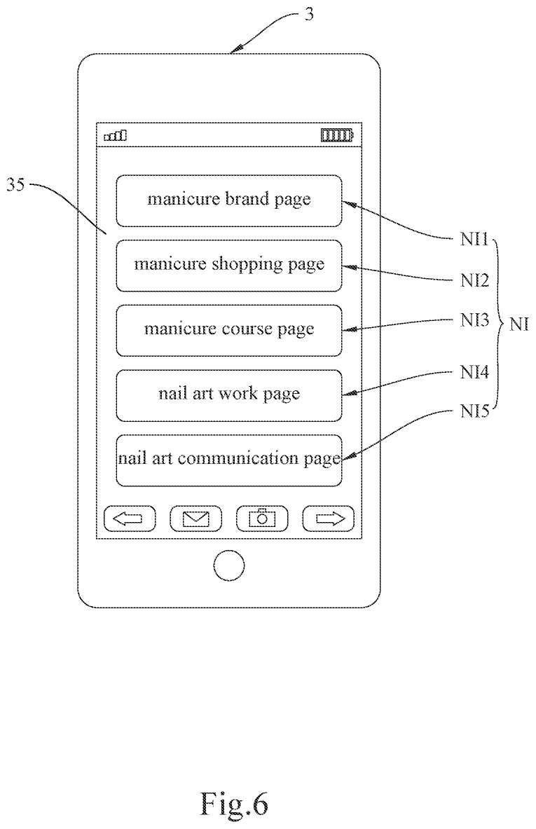

Next, please also refer to FIG. 6 showing a schematic diagram of the manicure information interface of the present invention.

The processor 32 is connected to the storage unit 34 and loads the storage unit 34 to execute the mobile application A. and outputs a manicure information interface NI on the display screen 35. Specifically, the manicure information interface NI is displayed on the display screen 35, where the manicure information interface NI may include a manicure brand page NI1, a manicure shopping page NI2, a manicure course page NI3, a nail art work page NI4, or a nail art communication page NI5, and the user can click to enter any page and connect to external web pages through the Internet to obtain more nail art related information. The manicure brand page NI1 can display the origin of the manicure machine brand, past news, latest news, contact information and other information so that the user can quickly get the latest news. The manicure shopping page NI2 can display various manicure products, overall sales rankings, product discount information, main recommended products this time and other information to improve the user's idea of purchasing peripheral tools or updating devices. The manicure course page N13 can display manicure course information, previous course records, domestic and foreign nail art competition or examination information, Q&A, etc. to provide the user with channels and methods for improving nail art techniques. The nail art work page NI4 can display nail art design drawings, photos of works, products used in the works, work release time, etc., providing a platform for manicurists and individual users to display their works. The nail art communication page NI5 can display, for example, product usage experience or other experience sharing for users to leave message or feedback their feelings about using the product. The content displayed on the above pages is not limited to the above specific embodiments, and can also be any information that can be publicly displayed on the Internet for unspecified persons or specific persons (such as members of a specific platform) to inquire. The manicure information interface NI can further display buttons with functions such as returning to the previous page, entering the next page, taking pictures, and sending and receiving data (as shown at the bottom of FIG. 6), which is convenient for the user to perform various operations. The present invention does not intend to limit the functions, display positions, number, etc. of the buttons on the manicure information interface NI.

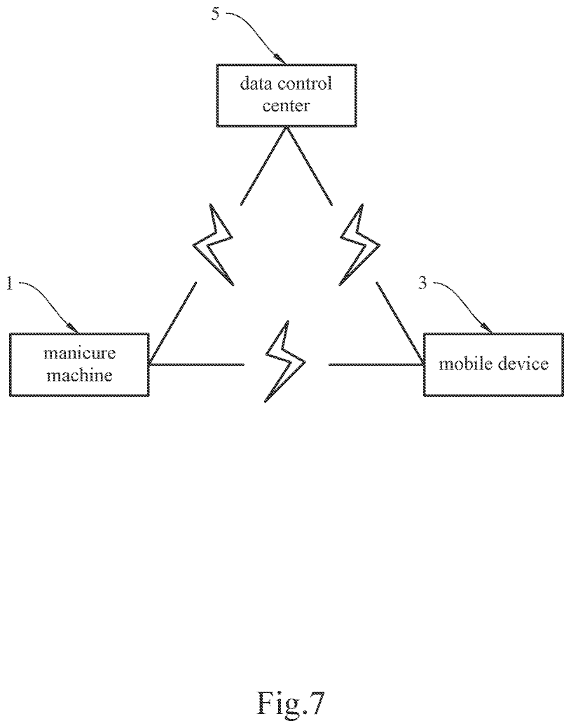

Next, please also refer to FIG. 7 showing a schematic diagram of the connection of the manicure machine, the mobile device, and the data control center of the present invention.

The mobile device 3 or the manicure machine 1 can be connected to a data control center to feedback the user's operation records to the data control center 5. The data control center 5 can be a background server, a computer host, or other such terminal devices without limitation. The data control center 5 transmits information with the manicure machine 1 and/or the mobile device 3 via a wireless connection. The data control center 5 has a database that can classify and manage the operation records, environmental information, manufacturing information and other information in the database DB, and generate big data by analyzing and processing a large amount of data, so as to realize the interaction and connection relationship between the user and the manufacturer of the manicure machine 1, which is beneficial for the manufacturer of the manicure machine 1 to provide users with more comprehensive intelligent services. Specifically, general big data can be analyzed through state data, interaction data, and transaction data. The state data is, for example, the information of the sensor 21 or the GPS positioning information of the mobile device 3, which can be used to analyze the actual application of the manicure machine 1. The interaction data is, for example, the user's interaction and links, such as posting or interaction on Twitter, Facebook, or Instagram, or web advertisement clicks, which can be used to analyze the user's preferences. The transaction data is, for example, transfer details, payment records, or transaction details, which can reflect the user's past records and serve as an analysis basis for predicting the user's future consumption.

In summary of the above, the manicure machine of the present invention is provided with a wireless communication module, which can be wirelessly connected with the wireless transceiver module of the mobile device, so that the user can directly operate the manicure machine or control the working state of the manicure machine by the mobile device, providing operational mobility and convenience.

The above is the detailed description of the present invention. However, the above is merely the preferred embodiment of the present invention and cannot be the limitation to the implement scope of the invention, which means the variation and modification according to the present invention may still fall into the scope of the invention.

1. A wirelessly connected manicure machine, including a housing, a control module, an input interface and a wireless communication module, wherein the housing has an internal cavity, an opening corresponding to one side of the internal cavity, and one or more ultraviolet light emitting diode (UV LED) modules provided in the internal cavity, the input interface is connected to the control module to input a corresponding trigger instruction to the control module, the control module is connected to the UV LED module, and the control module is also connected to the wireless communication module to send and receive signals through the wireless communication module.

2. The wirelessly connected manicure machine of claim 1, wherein the control module includes a storage unit with a database in which operation records or environmental information of the manicure machine are stored.

3. The wirelessly connected manicure machine of claim 2, wherein the storage unit further includes a look-up table including a plurality of nail polish information as indexes and a plurality of light-emitting mode information corresponding to the nail polish information, respectively.

4. The wirelessly connected manicure machine of claim 1 further including an output interface, which is connected to the control module to output corresponding man-machine signals according to a control instruction of the control module.

5. The wirelessly connected manicure machine of claim 4, wherein the control module is connected to a battery module that provides operating power to the UV LED module.

6. The wirelessly connected manicure machine of claim 5, wherein the control module outputs a power information of the battery module to the output interface according to a trigger instruction, and the output interface displays the power information.

7. The wirelessly connected manicure machine of claim 5, wherein the control module outputs a battery life information of the battery module to the output interface according to a trigger instruction, and the output interface displays the battery life information or the storage unit stores the battery life information.

8. The wirelessly connected manicure machine of claim 1, wherein the housing is provided with a speaker connected to the control module, and the control module executes a corresponding sound information according to a trigger instruction and the speaker outputs the sound information.

9. The wirelessly connected manicure machine of claim 1, wherein the housing is provided with a light-emitting module connected to the control module, and the control module adjusts the light-emitting color, light-emitting brightness and/or light-emitting position of the light-emitting module according to a trigger instruction.

10. The wirelessly connected manicure machine of claim 1 further including a radio frequency identification (RFID) reader, which reads an electronic tag to obtain and input a nail polish information.

11. A wireless connection system of manicure machine, including the manicure machine of claim 1 and a mobile device including a wireless transceiver module and a processor, wherein the mobile device is connected to the wireless communication module of the manicure machine through the wireless transceiver module to access the data of the control module.

12. The wireless connection system of manicure machine of claim 11, wherein the mobile device accesses the data of the storage unit.

13. The wireless connection system of manicure machine of claim 11, wherein the control module of the manicure machine executes a corresponding control instruction according to a trigger instruction received by the mobile device.

14. The wireless connection system of manicure machine of claim 11, wherein the mobile device includes a storage unit, and the processor is connected to the storage unit and executes a mobile application by loading the storage unit.

15. The wireless connection system of manicure machine of claim 14, wherein the mobile device includes a display screen connected to the processor for displaying information of the manicure machine.

16. The wireless connection system of manicure machine of claim 15, wherein the processor is connected to the storage unit and executes the mobile application by accessing the storage unit to output a manicure editing interface on the display screen.

17. The wireless connection system of manicure machine of claim 16, wherein the manicure editing interface includes a plurality of menus for a user to input, wherein the menus include a skin color menu, a nail shape menu, a nail polish menu, a nail position menu, and/or an operation menu.

18. The wireless connection system of manicure machine of claim 17, wherein the processor is connected to the storage unit and executes the mobile application by loading the storage unit to output a manicure information interface on the display screen.

19. The wireless connection system of manicure machine of claim 18, wherein the manicure information interface includes a manicure brand page, a manicure shopping page, a manicure course page, a nail art work page, or a nail art communication page.

20. The wireless connection system of manicure machine of claim 11, wherein the mobile device or the manicure machine is connected to a data control center and feedbacks a user's operation records to the data control center.
